(19) United States
(12) Patent Application Publication
(10) Pub. No.: US 2007/0152466 A1
(43) Pub. Date: Jul. 5, 2007

(54) COVER FOR A MOBILE DEVICE, AND METHOD FOR MAKING THE COVER

(75) Inventors: Qing Yang, Shenzhen (CN); Chia-Hua Chen, Shindian (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: SHENZHEN FUTAIHONG PRECISION INDUSTRIAL CO,.LTD., Shenzhen (CN); SUTECH TRADING LIMITED, Tortola (VG)

(21) Appl. No.: 11/551,675

(22) Filed: Oct. 20, 2006

(30) Foreign Application Priority Data
Dec. 30, 2005 (CN) 200510121413.6

(51) Int. Cl. B60P 7/02

(52) U.S. Cl. 296/100.06; 296/100.01

(57) ABSTRACT

A cover for a mobile device (100) includes a main body (10) and a view panel (30). The main body has a view opening (113) formed thereon and a window frame portion (11). The window frame portion has an inner rim (110) defining the view opening. The view panel has an outer rim (31). The view panel is injection molded in the view opening and integrally formed with the main body. The inner rim is engaged with the outer rim.

### BACKGROUND OF THE INVENTION

1. Field of the Invention

The present invention relates generally to covers for mobile devices and, more particularly, to a cover for a mobile device having a view panel and to a method for making the cover.

2. Description of related art

With the development of wireless communication and information processing technology, mobile devices, such as mobile telephones, are now in widespread use. These mobile devices enable consumers to enjoy the convenience of high technology services, anytime at virtually any location. A mobile device typically has a top cover and a view panel embedded in the cover. The view panel is a transparent plastic or glass lens, and is configured for protecting display elements accommodated in the mobile telephone from being damaged. Conventional covers and the view panels are not formed integrally. The view panel is adhered to the cover using adhesive in order to prevent the view panel from separating from the cover. However, the method of adhering the view panel to the cover cannot reach a desired level of airproof and dustproof performance, moisture and dust in the ambient air can enter into the mobile device, which causes damage to the mobile device. Furthermore, the cover and the view panel are made by two separate processes, which prolongs the time needed to produce the mobile devices.

What is needed, therefore, is a cover for a mobile device which has a more effective hermetic performance.

### SUMMARY OF THE INVENTION

In one embodiment thereof, a cover for a mobile device is provided. The cover includes a main body and a view panel. The main body has a view opening formed thereon. The view panel is received in the view opening and integrally formed with the main body.

Other advantages and novel features will become more apparent from the following detailed description of preferred embodiments when taken in conjunction with the accompanying drawings.

### BRIEF DESCRIPTION OF THE DRAWINGS

Many aspects of the cover for a mobile device can be better understood with reference to the following drawing. The components in the drawing are not necessarily drawn to scale, the emphasis instead being placed upon clearly illustrating the principles of the cover for a mobile device. Moreover, in the drawing like reference numerals designate corresponding parts throughout the several views.

FIG. 1 is a schematic view of a preferred embodiment of a cover for a mobile device;

FIG. 2 is similar to FIG. 1, but showing another aspect of the cover;

FIG. 3 is an exploded perspective view of the cover shown in FIG. 2;

FIG. 4 is an enlarged, cross-sectional view of the cover along line IV-IV in FIG. 1;

FIG. 5 is an enlarged view of the cover along line V in FIG. 4;

FIG. 6 is an enlarged view of the cover along line VI in FIG. 4.

### DETAILED DESCRIPTION OF THE INVENTION

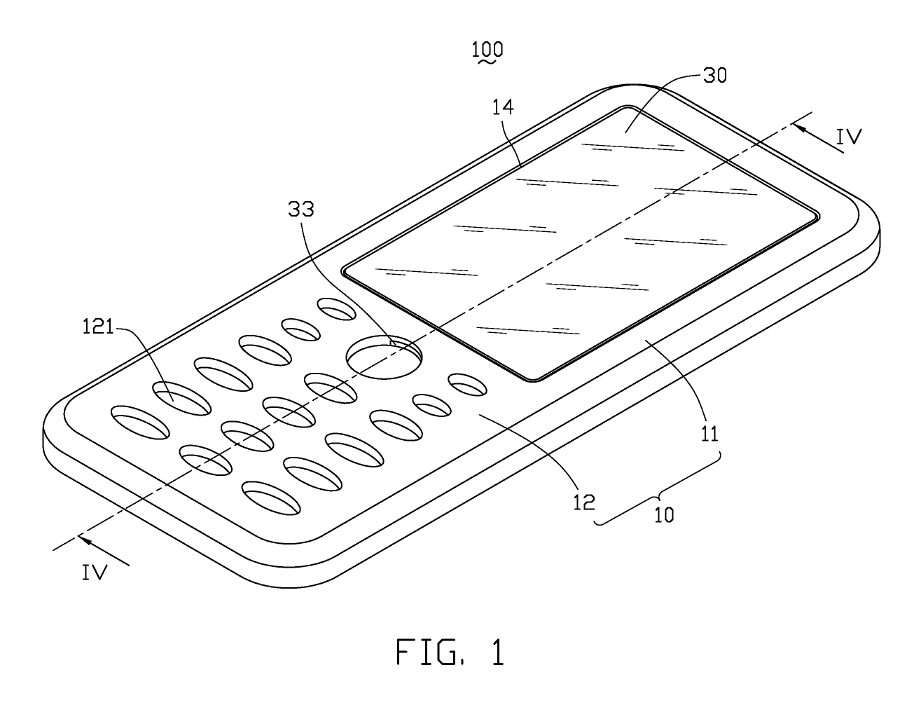

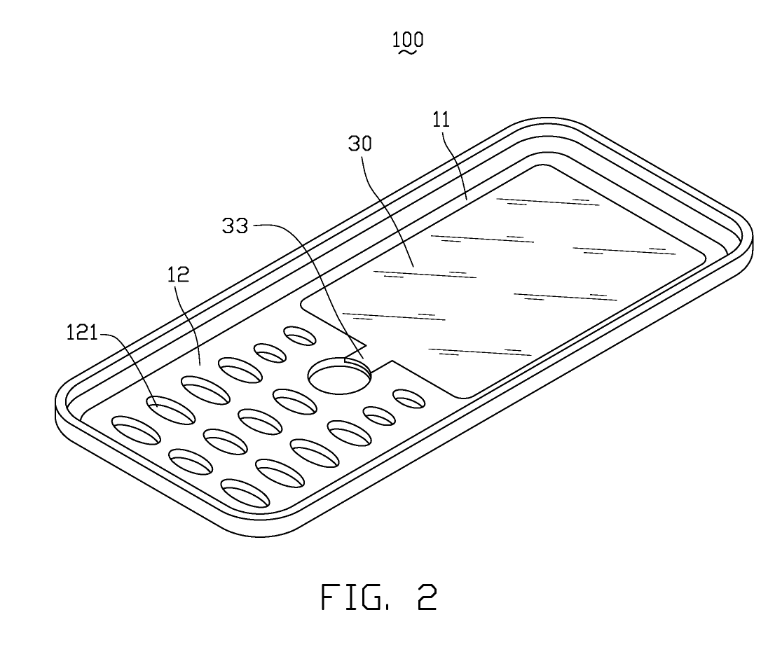

Referring to FIGS. 1-3, in a preferred embodiment, a cover 100 includes a main body 10 and a view panel 30.

The main body 10 has a window frame portion 11 and a keypad portion 12. The window frame portion 11 is provided with an opening 113 for receiving the view panel 30. The keypad portion 12 has a plurality of keyholes 121 formed thereon.

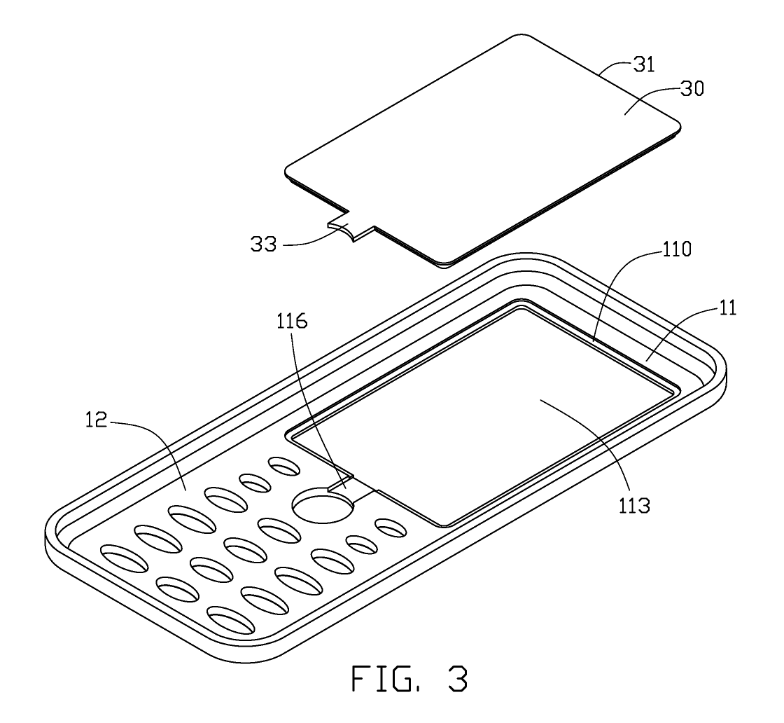

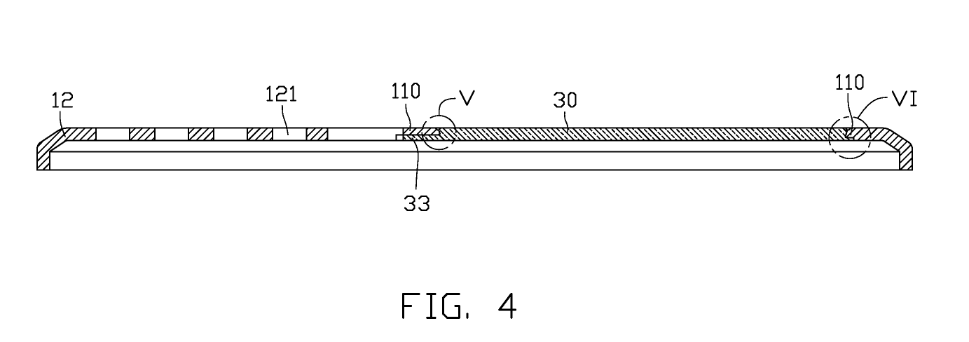

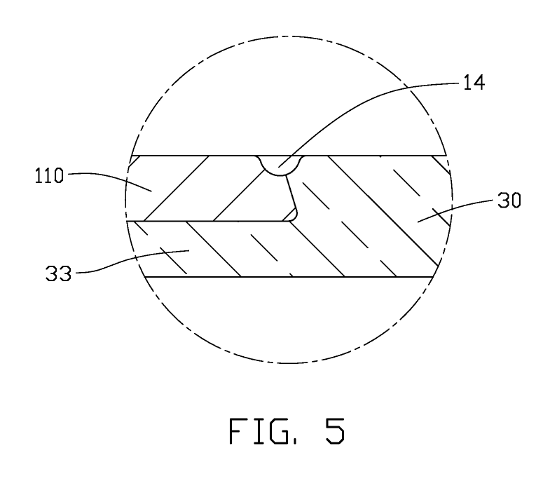

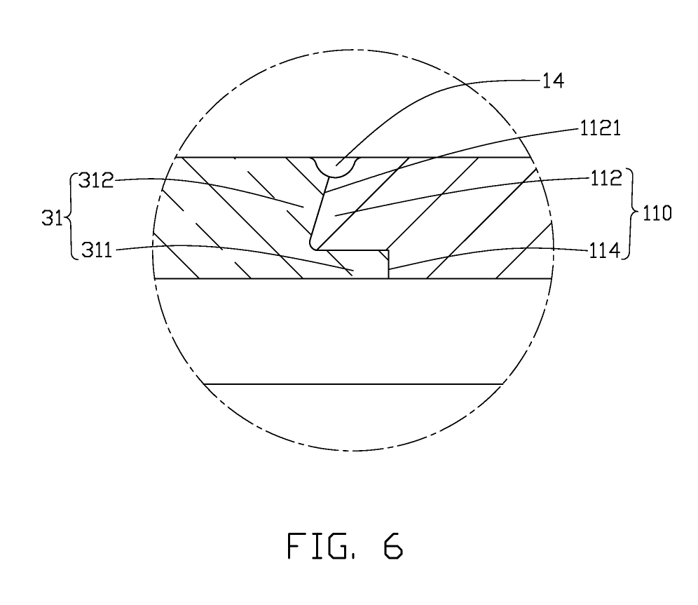

Referring to FIGS. 3-6, the window frame portion 11 has a stepped inner rim 110 defining the opening 113. The inner rim 110 has a first projected portion 112 and a recessed portion 114. The first projected portion 112 has a slanting sidewall 1121. A groove 116 is formed on the inner rim 110 and functions as a gate for injection molding the view panel 30. The view panel 30 is a transparent lens received in the opening 113, and integrally formed with the inner rim 110 of the window frame portion 11 by injection molding. Thus a stepped outer rim 31 of the view panel 30, engaging with the inner rim 110 of the window frame portion 11, may be formed, and a projected gate 33 of the view panel 30 may be formed in the groove 116. The stepped outer rim 31 of the view panel 30 has a second projected portion 311 formed in the recessed portion 114, and a slope portion 312 resisting the slanting sidewall 1121 of the first projected portion 112. An acute angle may be formed between a top face of the view panel 30 and the slope portion 312. Thus, the view panel 30 can be locked in the opening 113 via the engagement of the window frame portion 11 and the view panel 30.

The main body 10 is preferably made of a plastic material. The plastic material can be polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, or any desired combination thereof. The view panel 30 is, preferably, made of a transparent optical plastic material. The transparent optical plastic material can be polycarbonate, polymethyl methacrylate, polystyrene, or any desired combination thereof.

It should be understood, an arcuate groove 14 could be formed along the joint of the window frame portion 11 and the view panel 30. The arcuate groove can serve to prevent the sharp-angled point of the first projected portion 112 from being cracked.

It should be understood, the inner rim 110 of the window frame portion 11 can instead be provided with a first toothed cross section, correspondingly, the outer rim 31 of the view panel 30 can also have a second toothed cross section engaging with the inner rim 110 of the window frame portion 11.

An exemplary method for making the cover 100 is provided. Firstly, a main body 10 is molded in a first mold by injection molding. The main body 10 has a window frame portion 11 and a keypad portion 12. The main body 10 is, preferably, made of a plastic material. The plastic material can be polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, polypropylene, or any desired combination thereof. Secondly, the main body 10 is transferred to a second mold. Thirdly, a view panel 30 is integrally molded with the window frame portion 11 of the main body 10 in the second mold by injection molding. The view panel 30 should preferably be made of a transparent optical plastic material. The transparent optical plastic material can be polycarbonate, polymethyl methacrylate, polystyrene, or any desired combination thereof.

It should be understood, the view panel 30 can be fixed to the main body 10 by injection molding, thus in the process of making the cover 100, there is no need to fix the view panel 30 to the main body 10 using glue. The view panel 30 and the main body 10 can be joined together with no gap, thus the cover can obtain desired airproof and dustproof performance.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cover for a mobile device, comprising:
a main body having a view opening formed thereon; and
a view panel received in the view opening and integrally formed with the main body.

2. The cover as claimed in claim 1, wherein the view panel is integrally formed with the main body by injection molding.

3. The cover as claimed in claim 1, wherein the main body has a window frame portion, the window frame portion has an inner rim defining the view opening, the inner rim has a recessed portion, the view panel has an outer rim, the outer rim has a first projected portion received in the recessed portion.

4. The cover as claimed in claim 3, wherein the inner rim of the window frame portion has a second projected portion, the second projected portion has a slanting sidewall, the outer rim of the view panel has a slope portion resisting the slanting sidewall.

5. The cover as claimed in claim 3, wherein the inner rim of the window frame portion has a groove formed thereon, the groove functions as a gate for forming the view panel via injection molding.

6. The cover as claimed in claim 1, wherein the main body has a window frame portion, the window frame portion has an inner rim defining the view opening, the inner rim is provided with a first toothed cross section, the view panel has an outer rim, the outer rim has a second toothed cross section engaging with the inner rim of the window frame portion.

7. The cover as claimed in claim 1, wherein an arcuate groove is formed along the joint of the main body and the view panel.

8. The cover as claimed in claim 1, wherein the main body is made of a material selected from the group consisting of polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, and polypropylene.

9. The cover as claimed in claim 1, wherein the view panel is made of a material selected from the group consisting of polycarbonate, polymethyl methacrylate and polystyrene.

10. A method for making a cover for a mobile device, comprising the steps of: forming a main body by injection molding, the main body having a view opening formed thereon; and forming a view panel on the main body by injection molding; wherein the view panel is received in the view opening.

11. The method for making the cover as claimed in claim 10, wherein the main body has a window frame portion, the window frame portion has an inner rim defining the view opening, the inner rim has a recessed portion, the view panel has an outer rim, the outer rim has a first projected portion injection molded in the recessed portion.

12. The method for making the cover as claimed in claim 11, wherein the inner rim of the window frame portion has a second projected portion, the second projected portion has a slanting sidewall, the outer rim of the view panel has a slope portion resisting the slanting sidewall.

13. The method for making the cover as claimed in claim 11, wherein the inner rim of the window frame portion has a groove formed thereon, which functions as a gate for forming the view panel via injection molding.

14. The method for making the cover as claimed in claim 10, wherein the main body has a window frame portion, the window frame portion has an inner rim defining the view opening, the inner rim is provided with a first toothed cross section, the view panel has an outer rim, the outer rim has a second toothed cross section engaging with the inner rim of the window frame portion.

15. The method for making the cover as claimed in claim 10, wherein an arcuate groove is formed along the joint of the main body and the view panel.

16. The method for making the cover as claimed in claim 10, wherein the main body is made of a material selected from the group consisting of polyvinyl chloride, polyethylene terephthalate, acrylonitrile-butadiene-styrene, polycarbonate, polyimide, liquid crystal polymer, polyetherimide, polyphenylene sulfide, polysulfone, polystyrene, glycol-modified polyester, and polypropylene.

17. The method for making the cover as claimed in claim 10, wherein the view panel is made of a material selected from the group consisting of polycarbonate, polymethyl methacrylate and polystyrene.
